(19) United States
(12) Patent Application Publication
(10) Pub. No.: US 2005/0165804 A1
(43) Pub. Date: Jul. 28, 2005

(54) System and process for generating interactive learning packages

(76) Inventor: Todd Rothman, Smithtown, NY (US)

Correspondence Address: WILLIAM COLLARD;COLLARD & ROE, P.C., 1077 NORTHERN BOULEVARD, ROSLYN, NY, 11576, US

(21) Appl. No.: 10/909,475

(22) Filed: Aug. 2, 2004

Related U.S. Application Data
(60) Provisional application No. 60/492,349, filed on Aug. 4, 2003.
(60) Provisional application No. 60/492,866, filed on Aug. 6, 2003.
(60) Provisional application No. 60/503,951, filed on Sep. 18, 2003.

(51) Int. Cl. G06F 7/00

(52) U.S. Cl. 707/100

(57) ABSTRACT

A process and a system for creating a computerized interactive academic lesson. The process can include the following steps: searching through a plurality of data files; selecting at least one of these data files and/or adding at least one new data file to the existing data files; creating a content listing from the selected file and/or the added data file. Once the content listing has been created, a configuration or config file based upon the content listing of the plurality of data files is created wherein this content listing and the config file are stored as a separate interactive executable program. This separate executable program can be coupled with a content engine or player for running the executable file and then saved onto a disk such as a CD or a DVD disk and then distributed as a course or instruction.

### CROSS REFERENCE TO RELATED APPLICATIONS

The applicant hereby claims priority under 35 U.S.C. 119(e) from U.S. Provisional Patent applications 60/492,349 filed on Aug. 4, 2003 and 60/492,866 filed on Aug. 6, 2003 and Provisional application Ser. No. 60/503,951 filed on Sep. 18, 2003.

### BACKGROUND OF THE INVENTION

The invention relates to a process and a system for creating a computerized course instruction. Other systems and methods for generating and delivering courseware have been known in the art. For example, U.S. Pat. Nos. 6,162,060; 6,470,171; 6,535,713 all relate to a process for producing courseware over a computer wherein the disclosures of which are hereby incorporated herein by reference.

### SUMMARY OF THE INVENTION

A process for creating a computerized interactive academic lesson. The process can include the following steps: searching through a plurality of data files; selecting at least one of these data files and/or adding at least one new data file to the existing data files. This process can also include the step of creating a content listing from the selected file and the added data file. This can include generating a configuration or config file using a unique config file generator that uses the content listing of these data files to generate the config file. These config files and the content listing are stored as a separate interactive executable program.

For example, the computerized data file generator can generate a data file for an interactive question; a quiz question; an audio and video file; a chapter and glossary section; an animation including 2D and 3D images; and a chart.

This process can also include the step of encrypting a final content directory of at least one data file and the config file which is interpreted by the content engine. The above data can be coupled with the content engine for running a separate executable program and then saved onto a disk such as a CD or a DVD disk and then distributed as a course.

The system for creating the computerized interactive academic lesson can be housed on at least one computer having at least one data storage device, and at least one processor. The computer can have an archive of data files stored on the data storage device. There can also be at least one computerized course work builder stored in the data storage device and for sending a series of instructions to the processor. There is also at least one content directory for controlling and organizing a selected set of content of the archived set of data files.

This system also includes at least one config file generator for generating a configuration file based upon a selected assortment of archived data files. Once the config file has been generated, the system then uses at least one encrypter for encrypting the configuration file and the associated set of archived data files in at least one content directory to create a output file. The output file can be in the form of a separately executable file that can be stored on a disk such as a CD or a DVD. This CD or DVD can then be uploaded into a separate computer so that a user can review course material for his or her course or subject.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawing is designed for the purpose of illustration only and not as a definition of the limits of the invention.

In the drawings, wherein similar reference characters denote similar elements throughout the several views:

FIG. 1 is a flow chart showing the overview process for preparing a computerized course or educational pack;

FIG. 2A is an overview of a system for creating educational packs;

FIG. 2B is a first example of a hardware diagram for the system shown in FIG. 1A;

FIG. 2C is a second example of a hardware diagram for the system shown in FIG. 2A;

FIG. 2D is an overview of the structure and flow of information shown in FIG. 2A;

FIG. 3A is a basic diagram showing an example of the position of a content repository application in relation to a set of hardware;

FIG. 3B is a flowchart for creating a content repository application shown in FIG. 3A;

FIG. 4A is a schematic block diagram for an interactive question development generator;

FIG. 4B is a flow chart for the process for generating interactive questions;

FIG. 5A is a schematic block diagram of a question development center;

FIG. 5B is a flow chart for a quiz builder;

FIG. 5C is a screen shot for a graphical user interface for the quiz builder;

FIG. 6A is a schematic block diagram of the data flow of a Audio Video Compiler;

FIG. 6B is a flow chart for the process for compiling audio and video files using the audio video compiler in FIG. 5A;

FIG. 6C is a screen shot of the audio video compiler shown in FIGS. 6A and 6B;

FIG. 7A is a schematic block diagram of a chapter and glossary builder;

FIG. 7B is a screen shot of a chapter and glossary builder as shown in FIG. 7A;

FIG. 8 is a flow chart for the chart builder program;

FIG. 9A is a screen shot for a config file generator;

FIG. 9B is a screen shot for an output file for the config file generator;

FIG. 9C is a screen printing of a config file;

FIG. 10A is a block diagram of an educational pack player;

FIG. 10B is a content type listing of the programs stored in a player shown in FIG. 10A;

FIG. 10C is a screen shot of a player described in FIG. 10A;

FIG. 10D is a screen shot of the player shown in FIG. 10C wherein this player shows a demonstration of a quiz center program;

FIG. 10E is a screen shot of an interactive question shown in the player;

FIG. 10F shows an example of an animation in the player of FIG. 10A;

FIG. 10G shows an example of a digital chapter in the player of FIG. 10A;

FIG. 10H shows an example of a glossary window in the player of FIG. 10A;

FIG. 10I shows an example of a index pop up form in the player of FIG. 10A;

FIG. 10J is an example of a search form in the player of FIG. 10A;

FIG. 10K is an example of a process for the content engine; and

FIG. 10L is an example of a flow chart for the content engine.

### DETAILED DESCRIPTION OF PREFERRED EMBODIMENTS

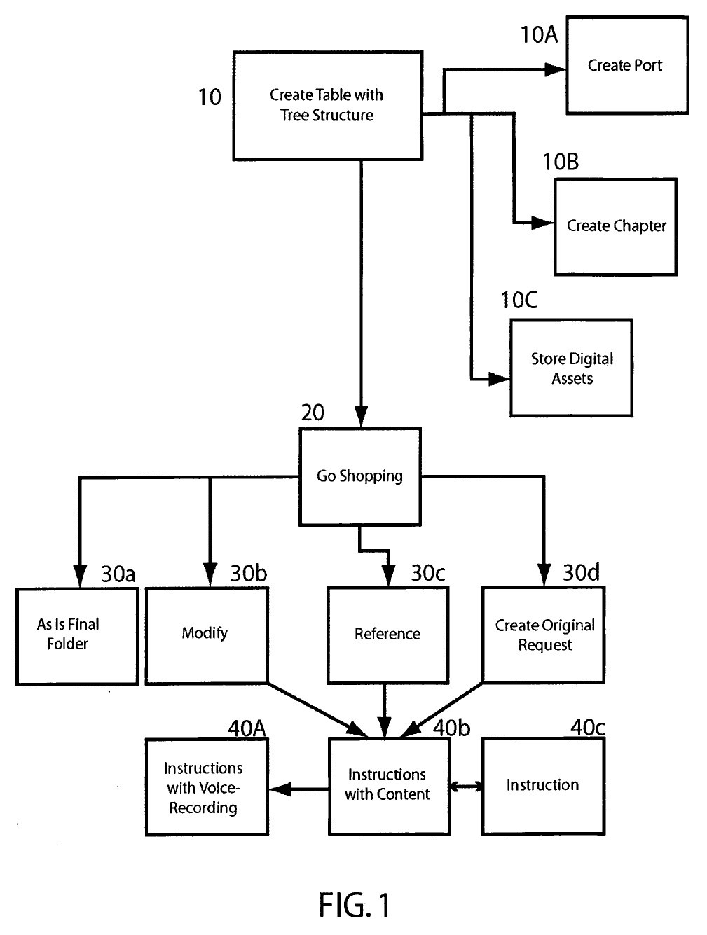

Turning now in detail to the drawings, FIG. 1 shows a flow chart of a process for creating an online or computerized course that can be stored on a CD-rom or DVD rom or any other type of storage medium. This process involves an interaction between a user who wishes to create a computerized course of instructions, a content consultant who can facilitate the creation of this course, including creating new or modified digital archived files, and a set of digital archived files that can be stored and searched in a centralized database. These files can be used as a repository or library wherein these files can be used as building blocks for creating a computerized course. A user or course creator such as a professor or a teacher, can create a table or tree structure in step 10. In creating this table or tree structure, the user can create different sub parts, chapters or sub chapters and also store digital assets in steps 10a, 10b and 10c respectively.

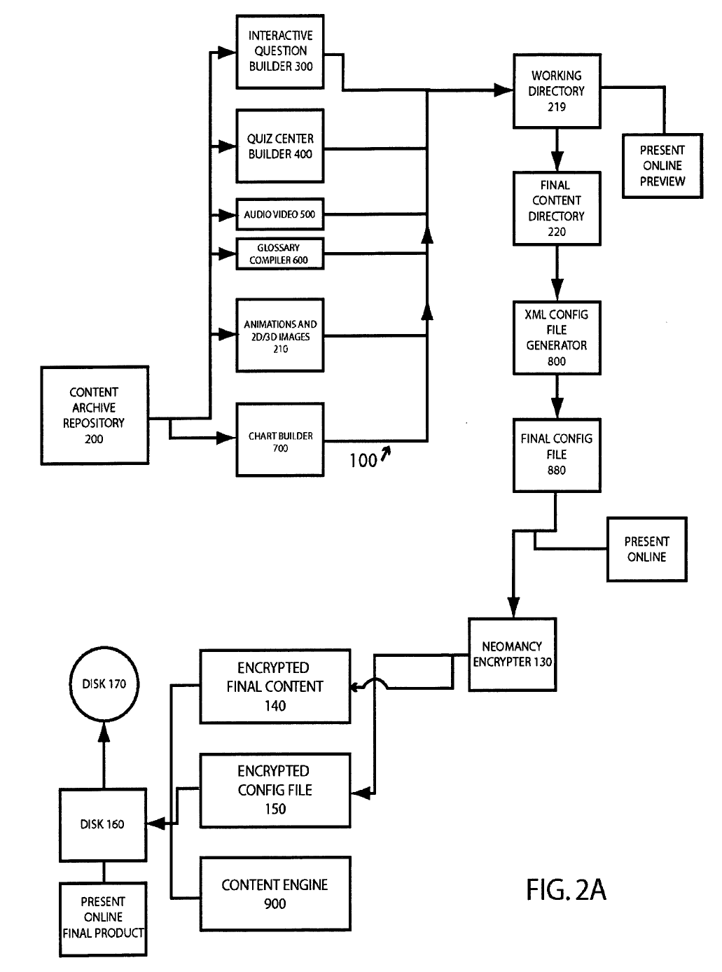

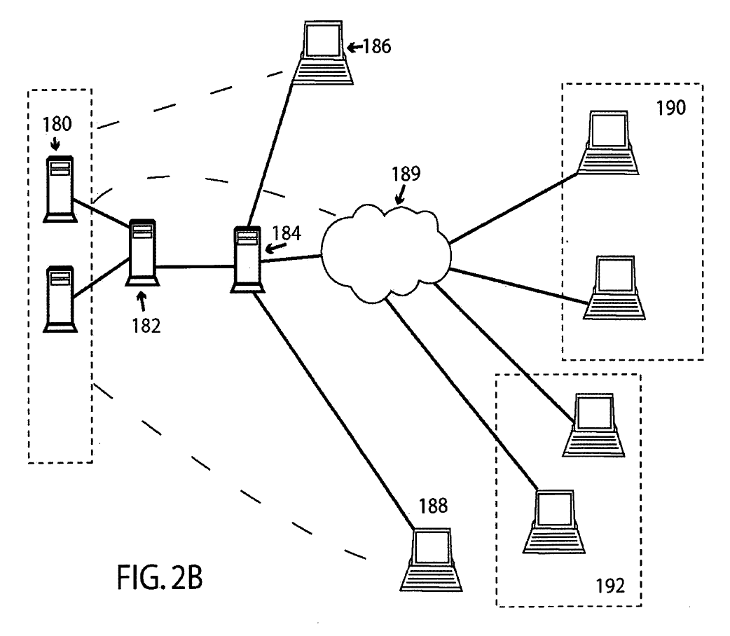

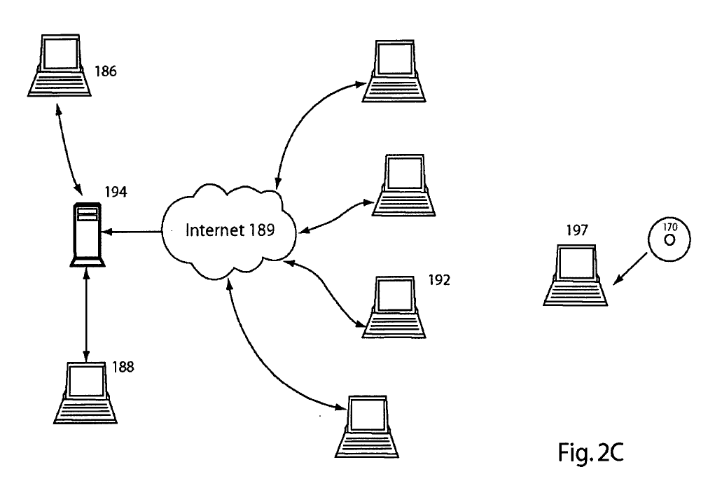

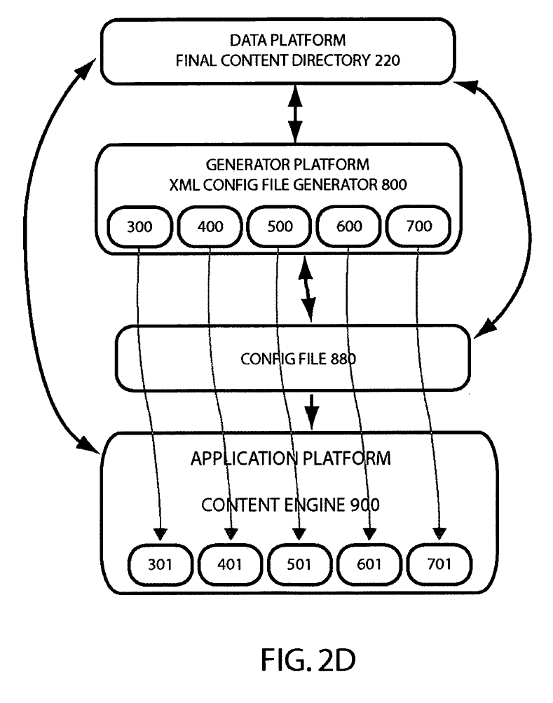

Next, the user can “go shopping” in step 20, wherein as the user is logged into a centralized database such as a content archive repository 200 shown in FIG. 2A, that user can then select the type of archived content for use with a particular course. Once the user selects a particular item in content archive repository 200, that user can then select that item for an “as is” folder wherein that information is then borrowed for use in the presentation in step without any further modification as shown in step 30a. Otherwise, the user can select a digital archive file wherein in step 30b the user can request a modification of that file through a standard web site request via either instructions with a voice recording in step 40a, instructions with additional digital content such as the selected digital archive file in step 40b or general typed or written instructions in step 40c.

If significant modifications are required, then the user can select a digital archive file as a reference file, and then request that an entirely new digital file be created by a content consultant.

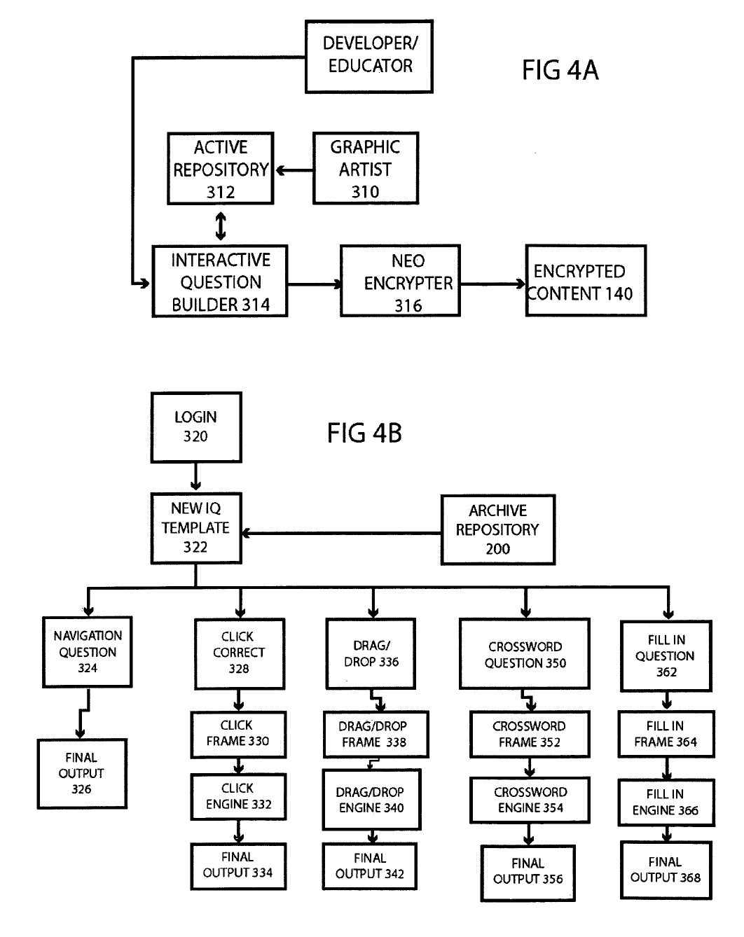

FIG. 2A shows an overview of the system 100 for building an interactive educational package. For example, there is a content archive repository 200 shown in greater detail in FIGS. 2A and 2B that serves as a database library for generating these educational packages. This content archive repository can be used to create an interactive question builder 300 shown in greater detail in FIG. 4A and 4B.

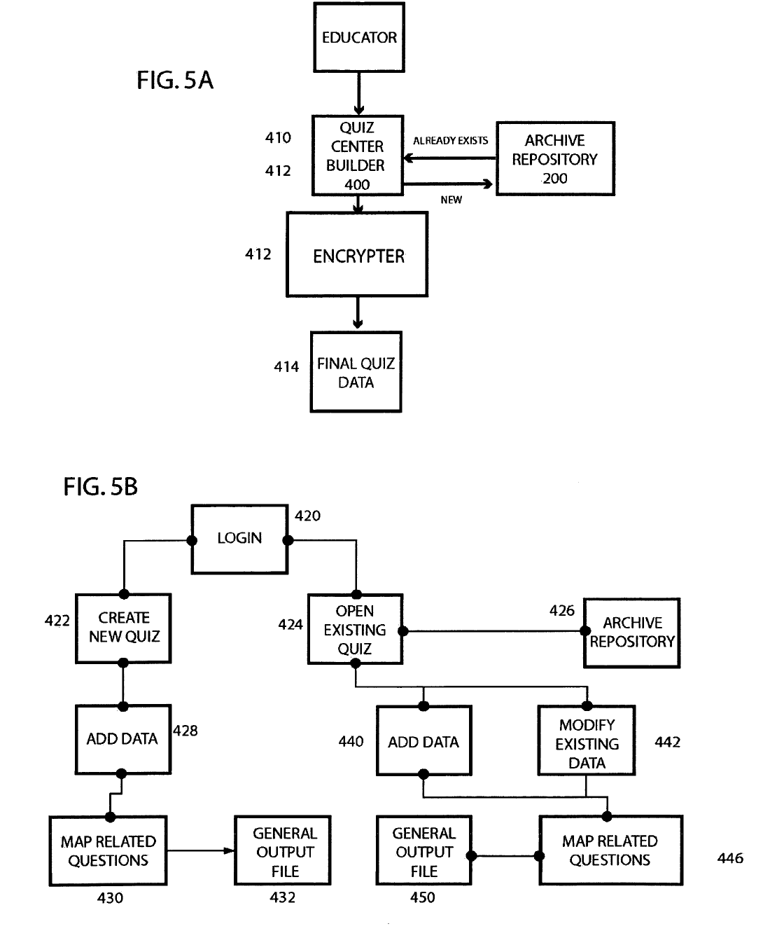

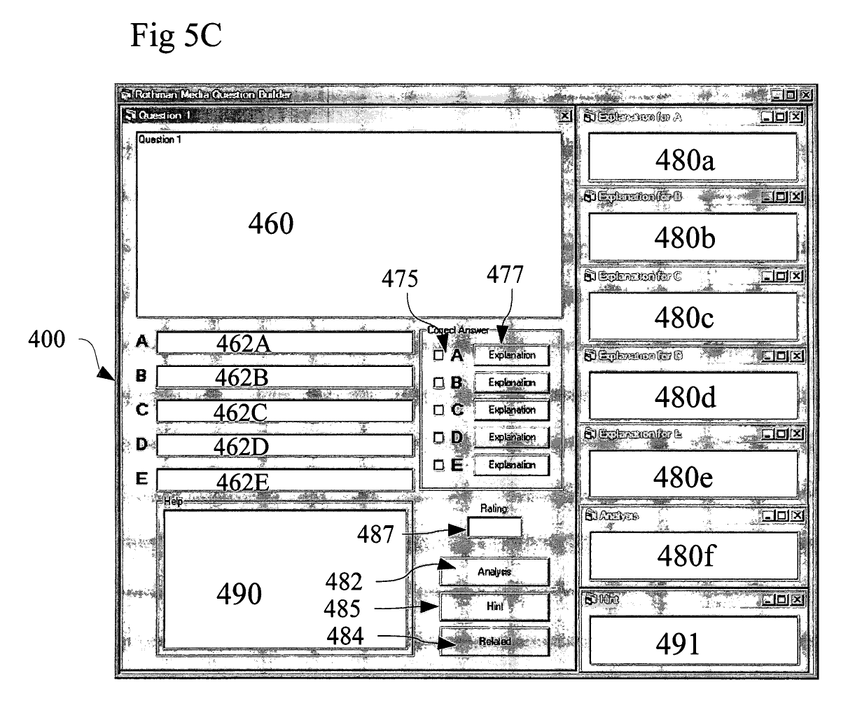

In addition, repository 200 can also be used to assist a quiz center question builder 400 shown in greater detail in FIGS. 5A and 5B to create interactive questions which are then incorporated into system 100.

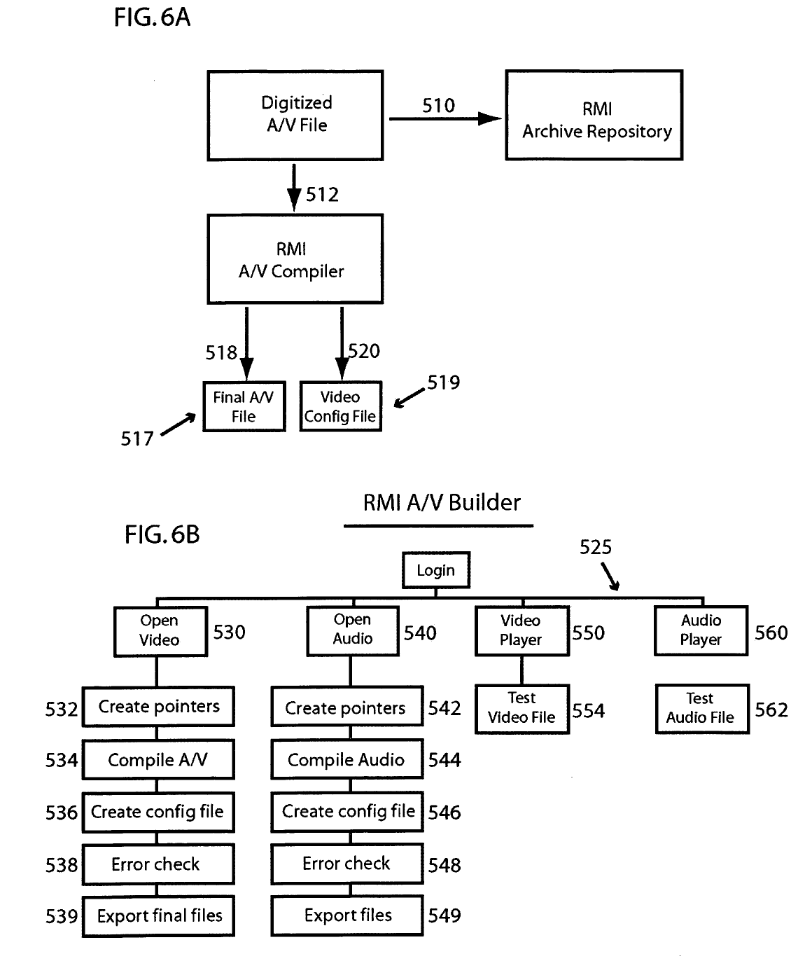

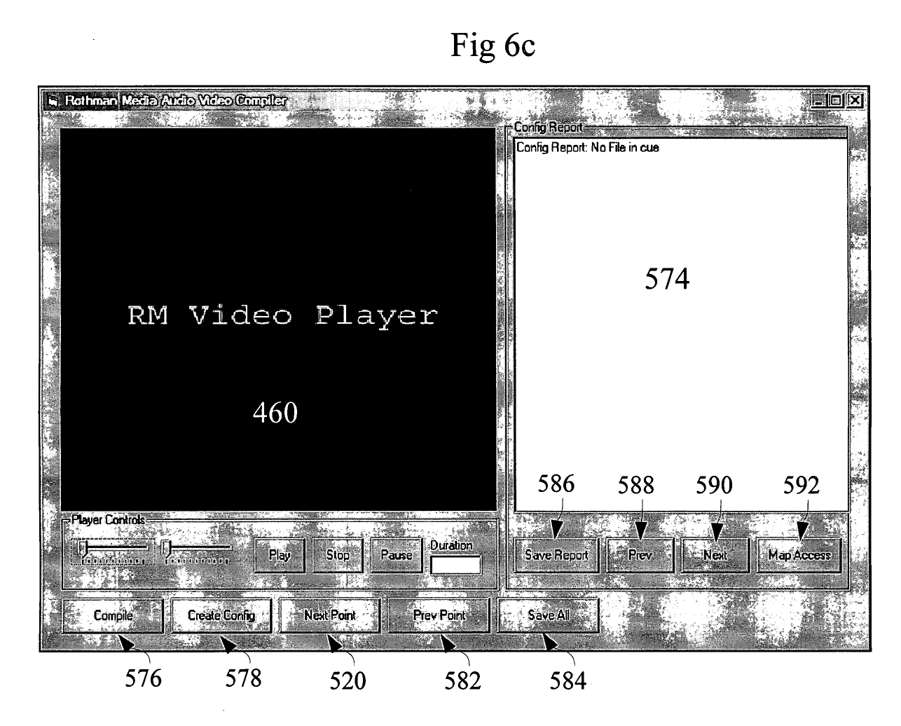

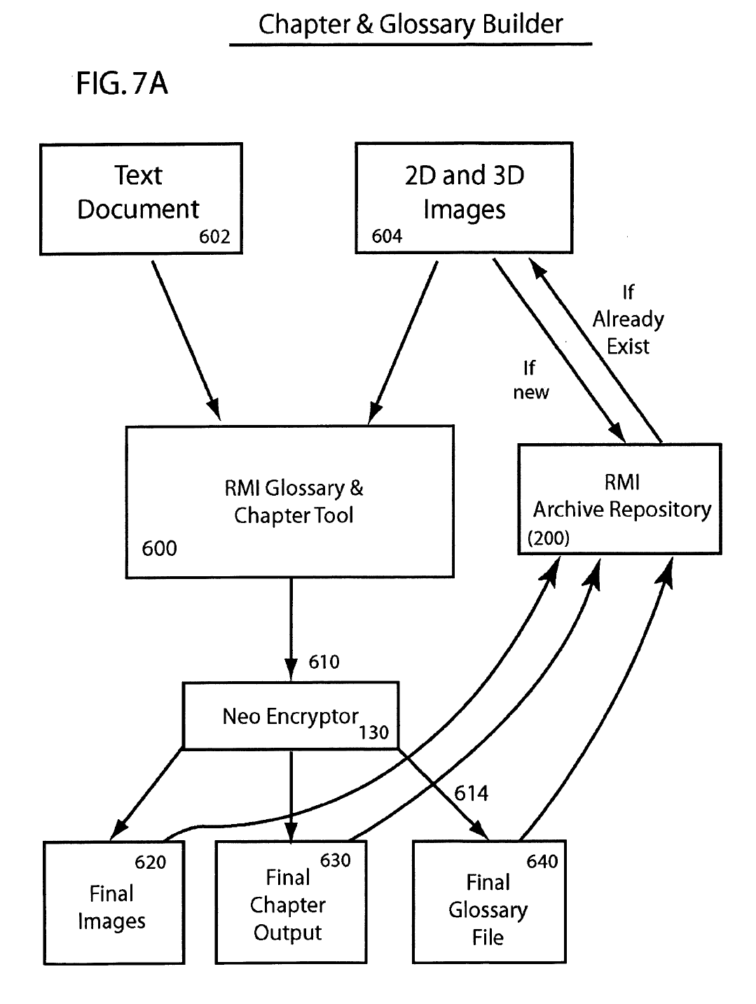

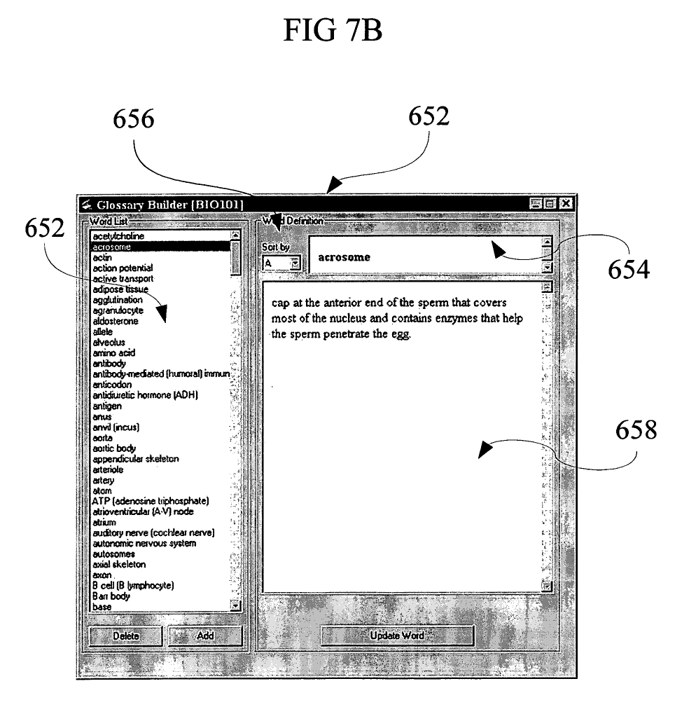

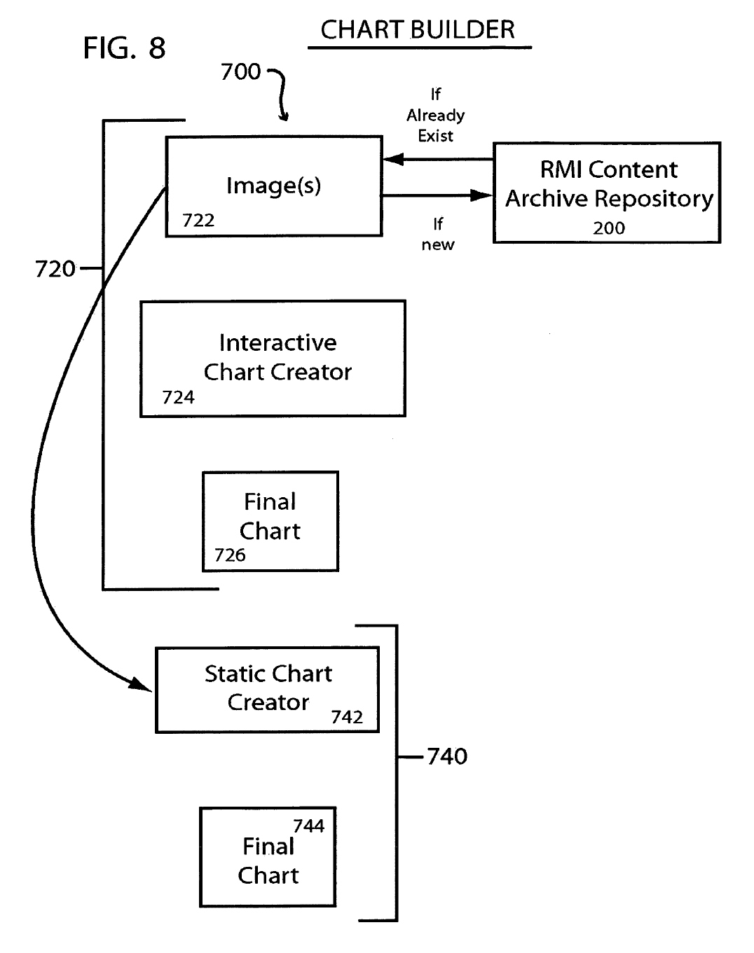

An audio and video compiler 500 shown in greater detail in FIGS. 6A and 6B can also be used to compile audio and video images into repository 200. Other features can be prepared such as a chapter and glossary builder 600 shown in greater detail in FIGS. 7A and 7B and any additional animation 210 including 2D/ or 3D images or even a chart builder 700 shown in greater detail in FIG. 8. Chart builder 700 is for showing interactive or static charts which can be used for explaining reactions such as chemical reactions.

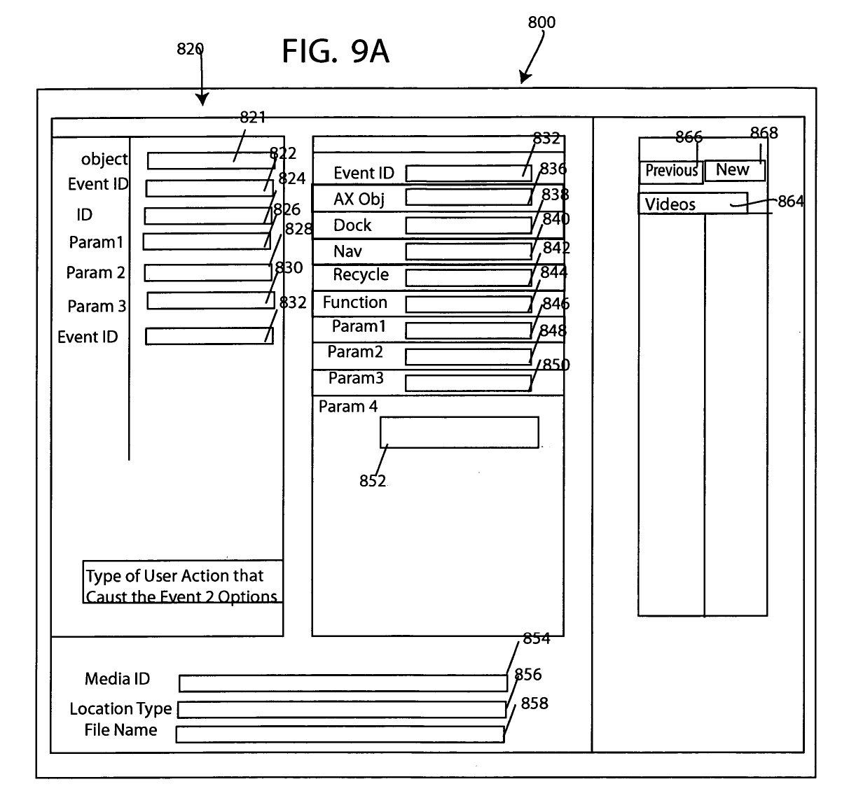

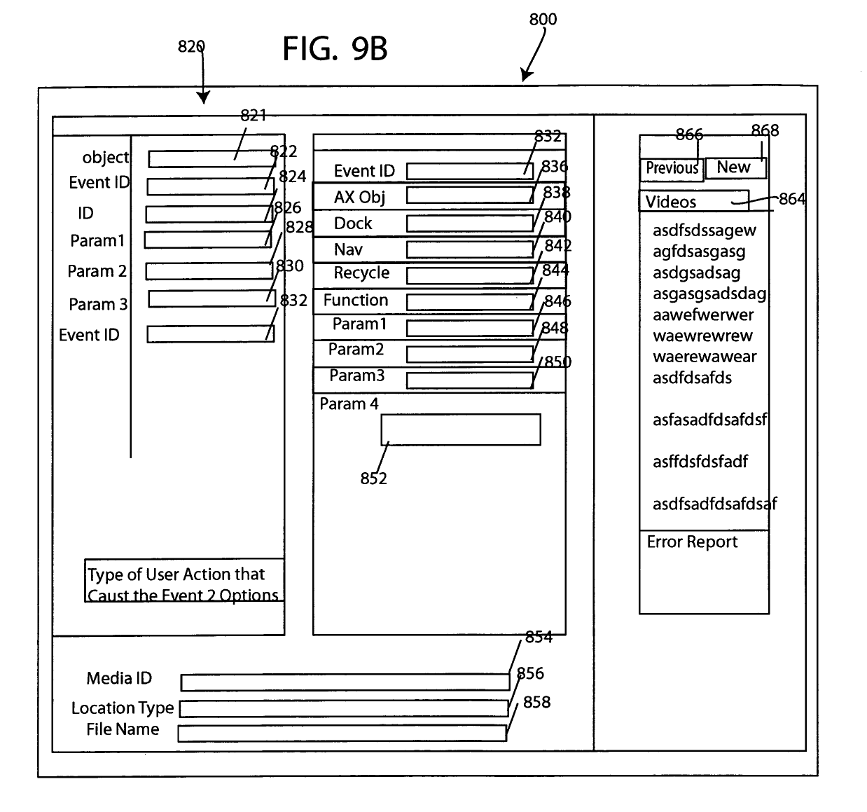

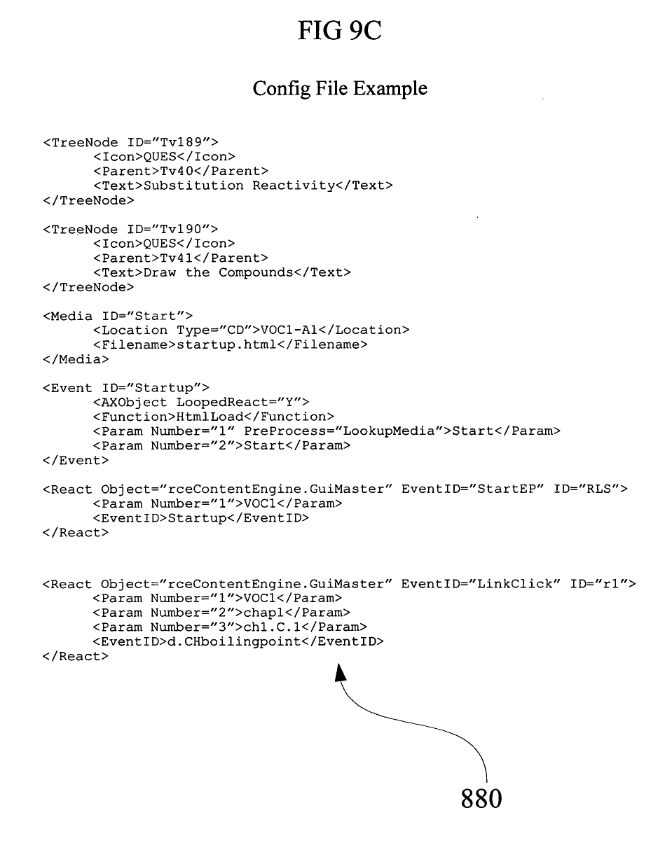

Essentially, the data in repository 200 passes through or is manipulated by one or more of the particular data manipulation engines 300, 400, 500, 600, or 700 wherein this manipulated information is stored in repository 200 and also presented in a final content directory 220. Information from this final content directory 220 is then forwarded on to an XML config file generator 800 which creates a final config file 880. This final config file is then encrypted by a neomancy encrypter 130 which then creates both an encrypted final content 140, and an encrypted config file 150. This encrypted final content 140 and config file 150 can then be read and accessed using a content engine 900 shown in greater detail in FIGS. 9A-9L. This information including the encrypted final content 140, encrypted config file 150 and content engine 900 can then be stored on a disk 170 such as a DVD or a compact disk (CD) via a drive 160.

FIG. 2B shows two examples of hardware profiles that can be used to create interactive educational packages and for viewing interactive educational packages. For example, there can be either an intranet or an internet connection ultimately to at least one data storage device 180 such as a server. Servers 180 can contain existing content archive repository 200 shown in FIG. 1A. Data servers 180 can be optionally coupled to at least one application server 182 which can be used to control the storage and retrieval of data in data servers 180. In addition, application server 182 can be used to run the following objects: interactive question builder 300; quiz center question builder 400; audio video compiler 500; chapter and glossary builder 600; and chart builder 700. Application server 182 can also be used to run XML config file generator 800, a neomancy encrypter 130, and a content engine 900. To protect application server 182 and data servers 180, both of these devices can be coupled to a firewall 184 which can be used to identify any users logging into application server 182 and data servers 180.

FIG. 2C shows an alternative form of hardware setup wherein only one server 194 is used to either service an intranet or an internet connection. One or more computers 186, 188, 190 or 192 can log into server 194 to generate the interactive educational package 100 described above. In addition, one or more of another type of computer 188 can be used to use or review the educational package in a learning environment. The input and construction of an educational package can also be performed over a computer network such as the internet 189 through computers 190 which would allow teachers, professors, or programmers to remotely create these educational packages. In addition, there could also be a plurality of computers to review and learn from this educational package through the internet. Finally, a stand alone computer 197 could be used to review and learn from this educational package via a data disk such as disk 170. Disk 170 could be loaded onto this stand alone computer 197 for the full presentation. Once the contents of this disk have been loaded into computer 197, it can in at least one embodiment be optionally updated through a connection through either the intranet or internet 189 to update the content that was uploaded into computer 197.

FIG. 2D is an overview of the structure of the flow of information shown in FIG. 2A. For example, a data platform which can be in the form of a final content directory 220 can be transformed using a generator platform in the form of an XML config file generator 800 which works with a plurality of different builders or compilers to form an output config file 880. These compilers or builders can include the following: interactive question builder 300, quiz center question builder 400, audio video compiler 500, chapter and glossary builder 600, chart builder 700 and also any animation or 2D and 3D images 210, which can be incorporated as separate files in any of the above builders or compilers. Config file 880 can then be read using the application platform which includes content engine 900. Content engine 900 includes a plurality of different readers which are particularly suited for reading the content stored in final content directory 220. These readers 301, 401, 501, 601, and 701, can be associated with their respective builders or compilers 300, 400, 500, 600 and 700, and take instructions from config file 880 to access data in a particular format or order from content directory 220. Thus, config file 880 sets the instructions to run application platform or content engine 900.

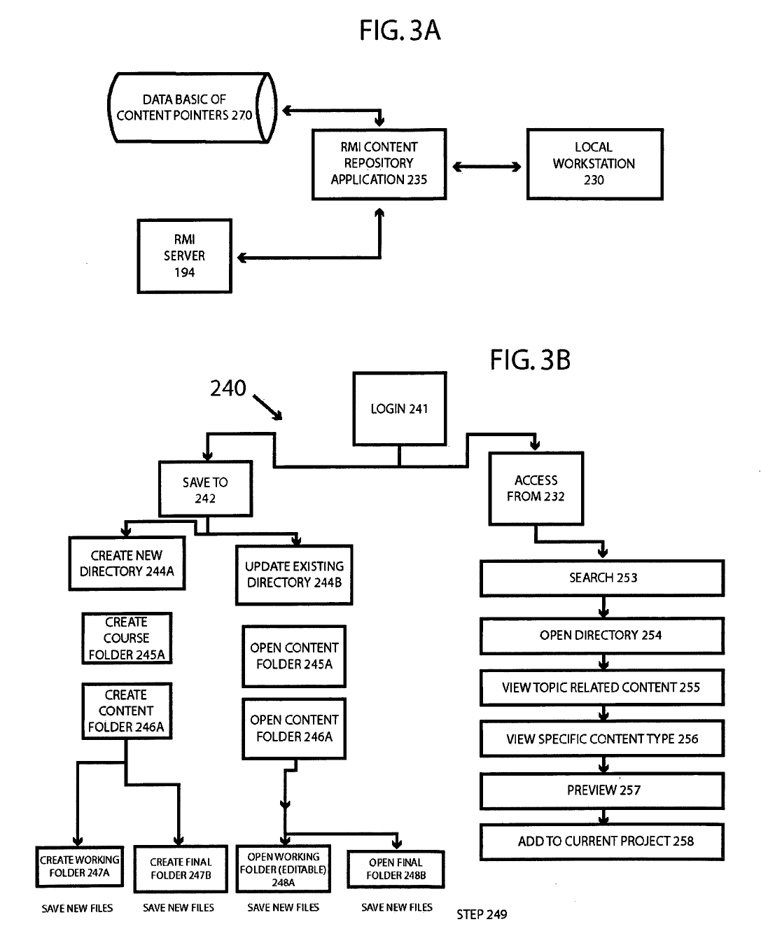

FIG. 3A shows the existing content archive repository. In this case, a local workstation 230 which can be similar to a workstation 186, 188, 190, 192 or 197 shown in FIGS. 2B and 2C could run a content repository application 235 which controls the content of repository 200. This information can be stored in a database 270 which is located on one or more of the servers shown in FIG. 2B or 2C or data storage devices 180, 194.

FIG. 3B shows a flow chart 240 detailing the process for creating an interactive educational package. For example, in step 241 a user can log in to a server and in step 242 either upload or save existing data to repository 200 or in step 252 search for data in repository 200. If a user wants to save new data, he or she could create a new directory in step 244a, and then create a course folder in step 245a, and then create a content folder in step 246a which can result in the creation of a working folder in step 247a or a final folder in step 247b. This final folder is locked down via encryption using neomancy encrypter 130 as shown in FIG. 2A.

Alternatively, the user could update an existing directory in step 244b. This action occurs by opening an existing course folder in step 245b and then open an existing content folder in step 246b wherein this information can then be saved into a working folder in step 248a or saved into a final folder in step 248b wherein this information is locked down via using neomancy encrypter 130 shown in FIG. 2A. These files are then saved into repository 200 in step 249.

If instead of uploading new data, the user was interested in accessing existing data in repository 200, then he or she could search for this information in step 253, wherein once this information is found, the user can open a directory in step 254, view a related topic in step 255, view a specific content type in step 256, preview this information in step 257 and then add this information to their current project in step 258.

FIG. 4A shows the process for creating an interactive question. In this process, as in step 310, a graphic designer or graphic artist creates a new graphic that can then be added to repository 200 in step 312. Next, in step 314 this information can be manipulated by a question generation engine 300 which allows a user/question designer to take any art or other types of media stored in repository 200 and manipulate it into final content. This information is then encrypted in step 316 wherein the encrypted content is then locked down in step 318 and stored in repository 200 in a final version.

FIG. 4B shows the process for using interactive question engine 300 shown in FIG. 2A wherein in this process in step 320 a user can log in and in step 322 obtain a new template which can be used in step 324, to create navigation questions, wherein in step 326 this question is then saved as a final output in repository 200. Step 328 can involve creating click correct questions, which involves step 330 which results in using a click frame, next in step 332, a click engine is activated to create a final output in step 334. Step 336 involves creating drag/drop questions, which includes step 338 involving using a drag/drop frame, next, in step 340 the user can activate a drag/drop engine to create a final output in step 342.

Step 350 involves creating a cross word question which includes using a cross word frame 352 and then manipulating this cross word frame using a cross word engine in step 354 to create a final product in step 356. Another option would be to create a fill-in question in step 360 wherein this step includes using a fill-in frame in step 362 and then also in step 364 using a fill-in engine to manipulate the fill in frame to create a final product in step 366.

Along with interactive questions, quiz questions can also be created. For example, FIG. 5A discloses using a quiz center question development device wherein an educator/user can use a quiz center builder in step 410 to create quizzes which are stored in repository 200. This information is next encrypted in step 412 and then formed as a final set of data in step 414.

FIG. 5B shows a more particular process of step 412, which involves forming or building a quiz. In this case, a user can login in step 420 wherein the user can, in step 422 create a new quiz. Next, the user can add data in step 428 and then map related questions in step 430. Next, the user can create a general output file 432 from these questions.

Alternatively, the user can open an existing quiz, 424 and then search repository 200 in step 426 so that data can be added in step 440 or data can be modified in step 442. Next, any related questions can be mapped in step 446 and then this can be sent to a general output file 450.

FIG. 5C shows a screen shot of a quiz center builder or engine 400 wherein this quiz center builder 400 includes a question input field 460 a plurality of answer input fields 462a, 462b, 462c, 462d, 462e, a help field 470, a correct answer selection field 475 and an explanation screen for each of these fields 480a, 480b, 480c, 480d, 480e; an analysis button 482 which triggers a statement in an analysis field 480f or a related button 484 which triggers a listing of related questions or topics including links to those related questions or topics stored in a related field (not shown). There is also a hint button 485, a rating field 487 and a set of explanation buttons 477. Hint button can be linked to a hint screen 491 so that when a user clicks on a hint screen he or she can see a hint about a particular question.

FIG. 6A shows a overview process for compiling audio and video files. For example, to create or view a file, a user can, in step 510 access repository 200 to obtain a copy of this file. Alternatively, the user could insert an additional new file into repository 200. In step 512, an A/V compiler 500 creates a final A/V file 517 in step 518 which is stored as a data file in repository 200 and a config file 519 in step 520, which is used to manipulate and access an A/V file 517 in repository 200.

FIG. 6B shows the process 525 for creating audio visual files. For example, this process can include opening an existing video file in step 530 to create pointers in step 532, compile A/V information in step 534, and create a config file in step 536. In addition, the user can next conduct an error check in step 538, and then export these final files in step 539.

Similarly, if the user wanted to manipulate audio files he or she could open an audio file in step 540, create pointers in step 542, compile this audio information in step 544, create a config file in step 546, error check in step 548, and then export these files in step 549. These files are essentially exported to a final content directory 220.

As stated above, the user could also create new files such as in step 550 wherein the user operates a video player and then creates a video file in step 554. Alternatively the user could operate an audio player in step 560 wherein the user could then test this audio file in step 562.

FIG. 6C shows this customized video player wherein this video player 570 includes a video playing screen 572 and a video configuration file field 572 which can be used to configure this video file. This device includes a compile button 576, a create config button 578 which is used to create a config file, as shown in steps 536 and 546 in FIG. 5B. There is also a next point button 580 and a previous point button 582 which is used to create or move to points in the ongoing clip. These points provide links or markers in the flow which can then be used to jump to a particular marked location.

A save all button 584 can be used to save the progress in editing the clip to save the data while a series of buttons such as a save report 586, previous 588, next 590 and a map access 592 can be used to control the content of the config file in the screen 574.

FIG. 7A discloses a schematic block diagram for a chapter and glossary builder. This chapter and glossary builder includes a glossary and chapter tool 600 which can be used to receive a text document 602, or 2D and 3D images 604, wherein this information can then be stored in repository 200 such as in final content directory 220. The 2D and 3D images can then be paired with the text and then be used to help explain each of the definitions. This information can be sent to an encrypter 130 in step 610 for encryption, wherein final files including final images 620, final chapter output files 630, and final glossary files 640 are then stored in repository 200 as well in step 614.

FIG. 7B shows a screen shot of a utilization of this information wherein there is shown a screen 650 which includes a word list field 652, a word definition field 654, a sort by field 656, and an open full definition field 658. Essentially, field 652 provides a listing of the words in alphabetical order. Once the word has been selected in field 652 the definition appears in word definition field 654 and also appears in full definition field 658.

FIG. 8 discloses a chart builder wherein this chart builder includes a plurality of images 722 which can be manipulated using an interactive chart creator 724 which can be used to create a final chart 726. There is also a static chart creator 740 process which can be used with a static chart creator 742 to create a final static chart 744.

All of the information from these builders as described above is stored in repository 200 in a final content directory 220. This information is then transformed into an XML config file using an XML config file generator outlined in greater detail in FIGS. 8A-8E.

For example, the user can then use the XML builder application 800 shown in FIG. 8A to create a final XML config file. (Note please explain significance of each of the fields.) Generator 800 includes the following fields: an object field 821, an event id field 822, an id field 824, a parameter 1 field 826, a parameter 2 field 828, a parameter 3 field 830, and an event id field 832 in a first column 820. The second column discloses the fields associated with event id field 832, this column includes an AX object field 836, a dock field 838, a Nav field 840, a recycle field 842, a function field 844, a parameter 1 field 846, a parameter 2 field 848, a parameter 3 field 850 and a parameter 4 field 852. Media that is generated is identified by a media section which includes the following fields: a Media id field 854, a location type field 856, and a file name field 858.

There is also an additional window 860 that can be used to control videos which includes a first field 861 on a left hand side and a second field 862 disposed on a right hand side. There is also a scroll-down bar 864 which is used to select the particular content that is being edited and two separate buttons, previous 866 and next 868 which can be used to scroll through the options in the scroll-down bar to select other files for generating a config file.

FIG. 9B shows the XML builder 800 screen, however this view shows a preview XML screen 870 which shows the XML code disposed in this screen and also an additional error report field 875 which discloses an error report for the XML code generated.

FIG. 9C shows the output file 880 for the XML code wherein this output file is indicative of a typical XML output file that can be generated for a user. This XML config file is stored in repository 200.

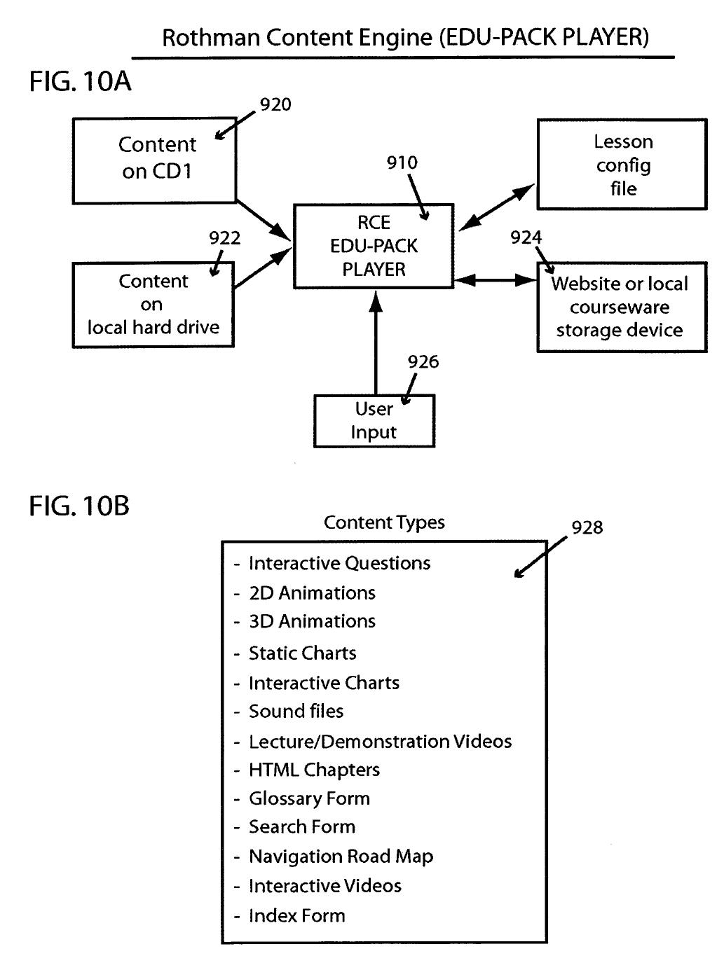

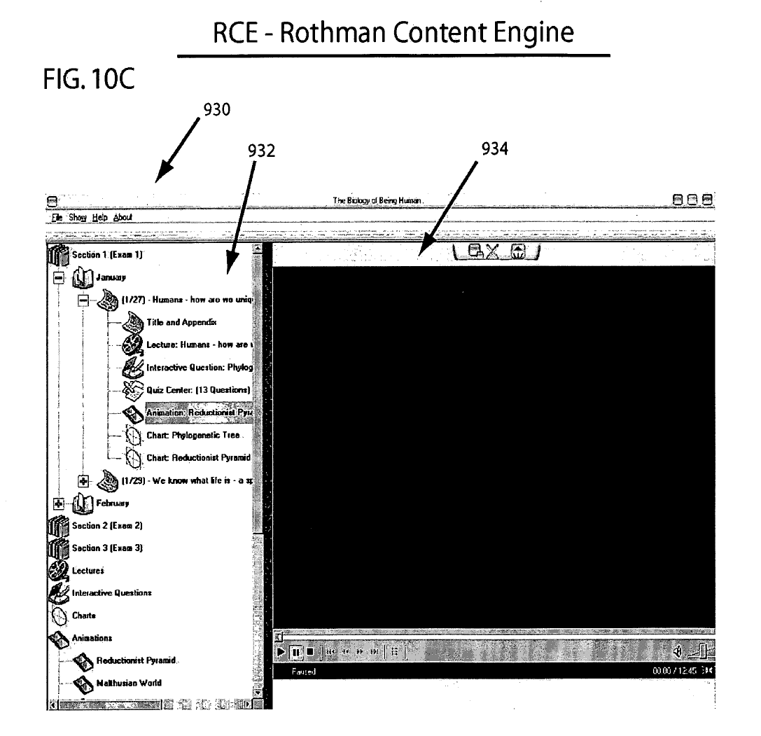

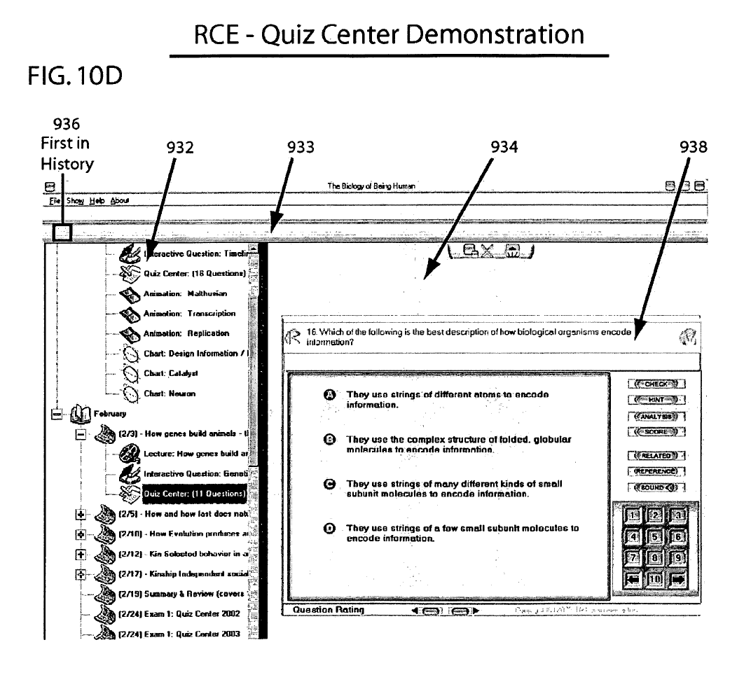

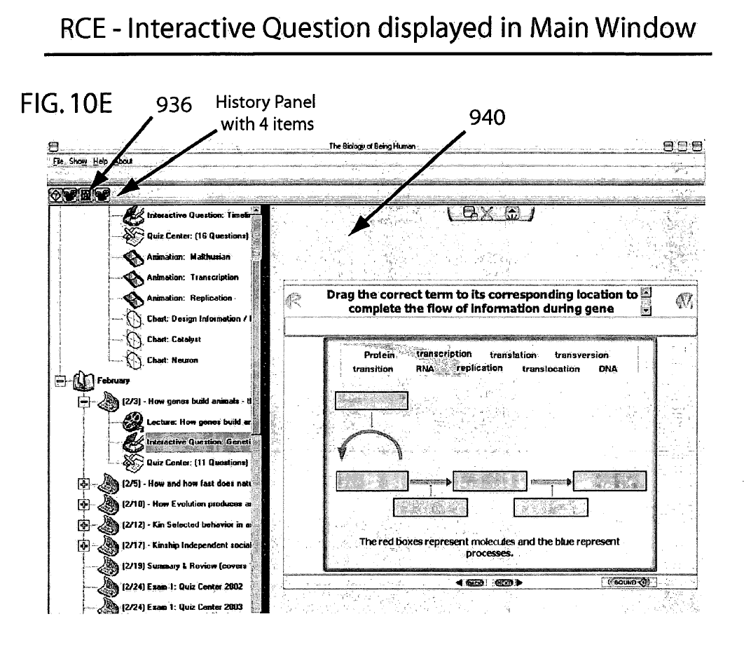

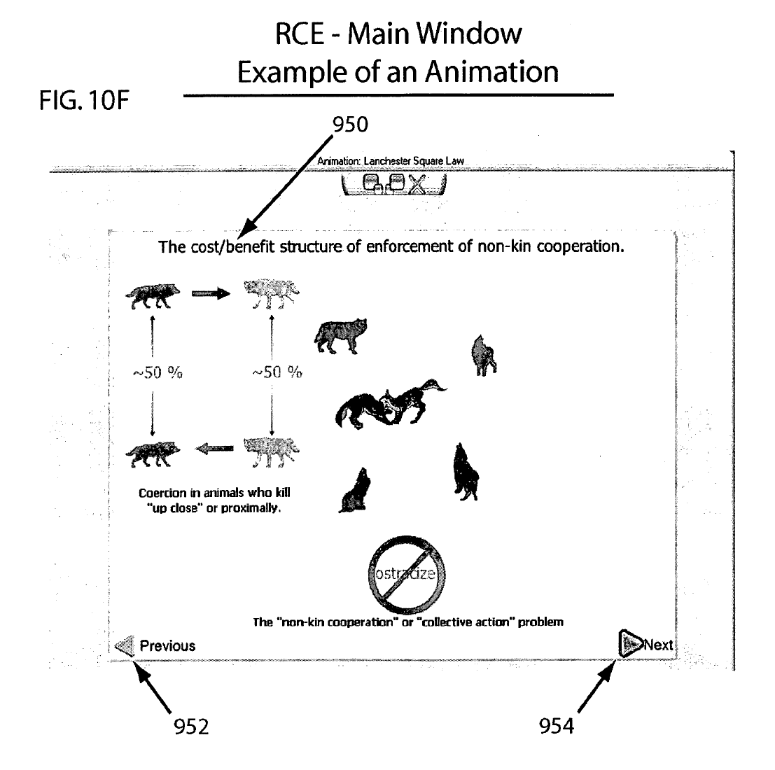

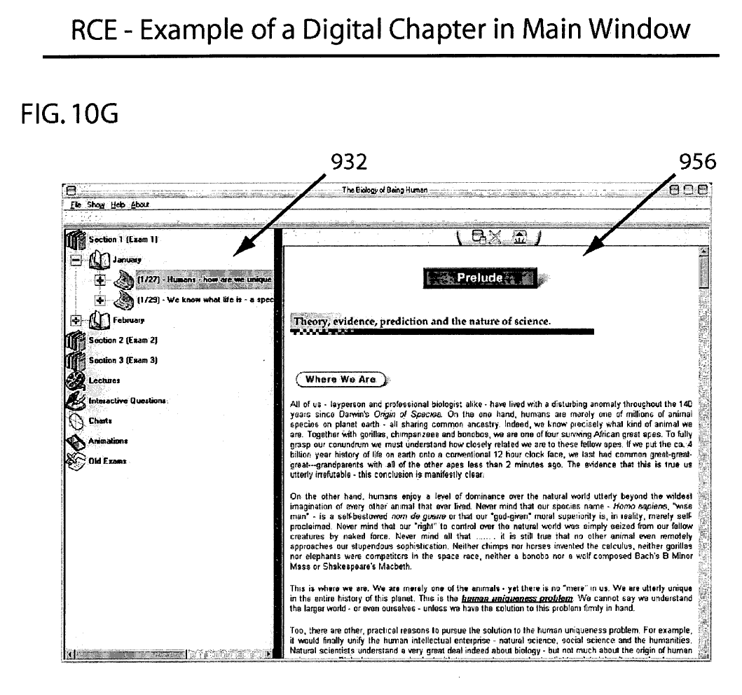

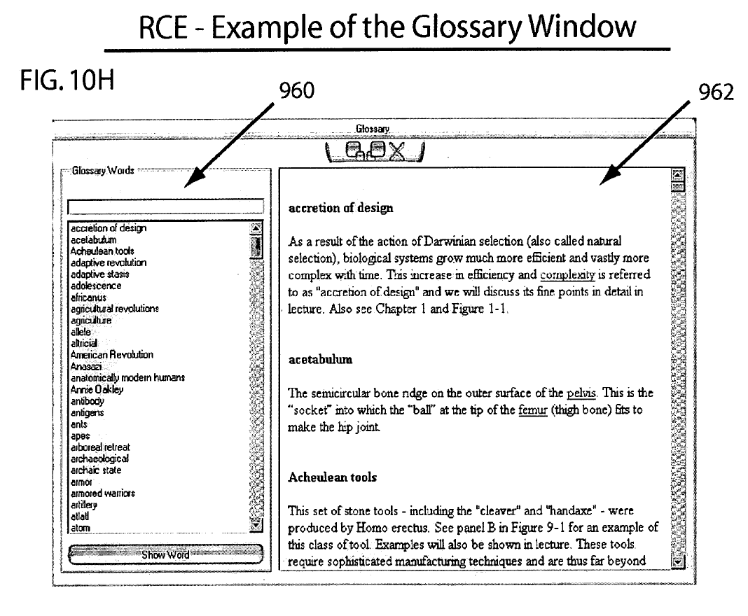

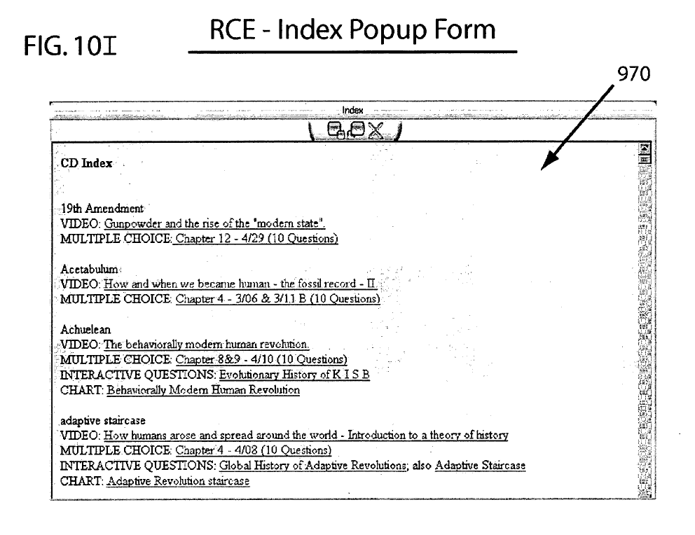

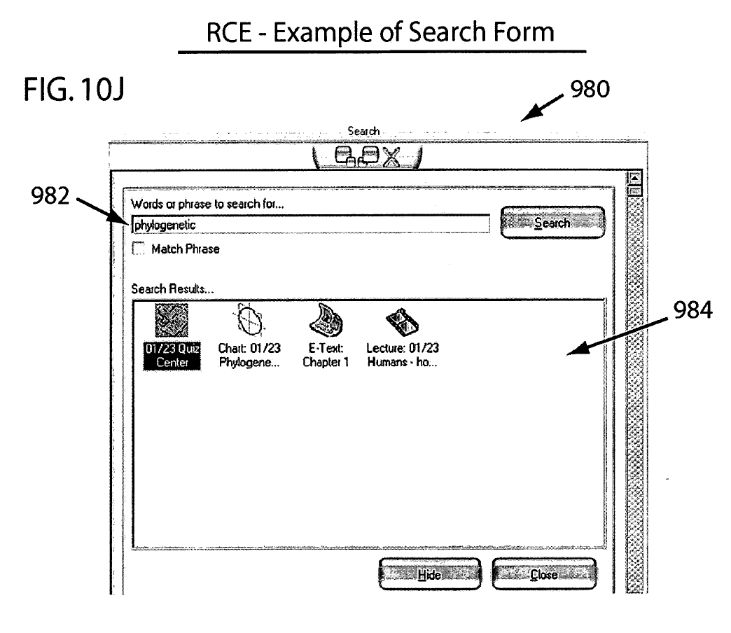

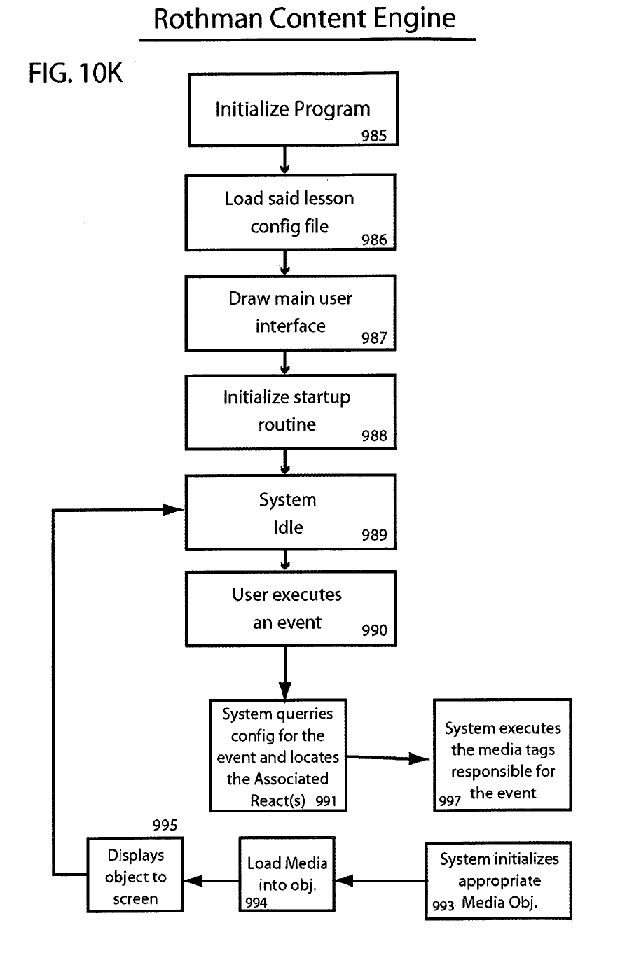

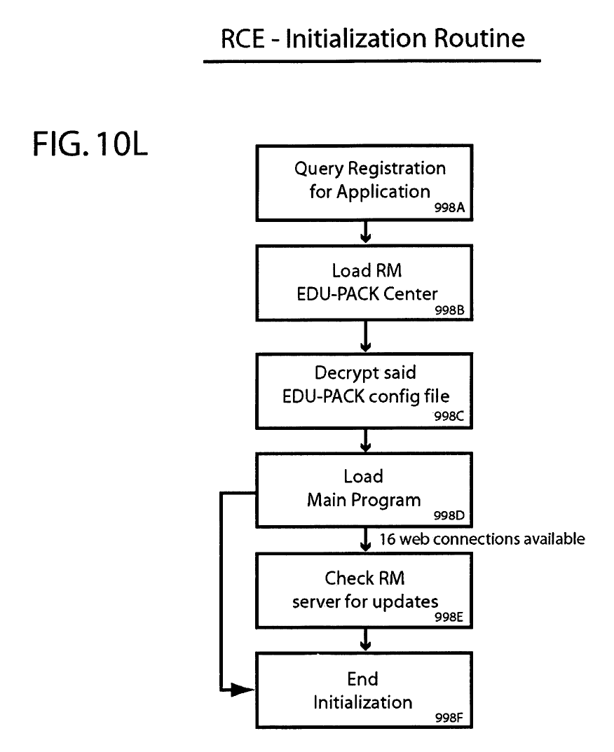

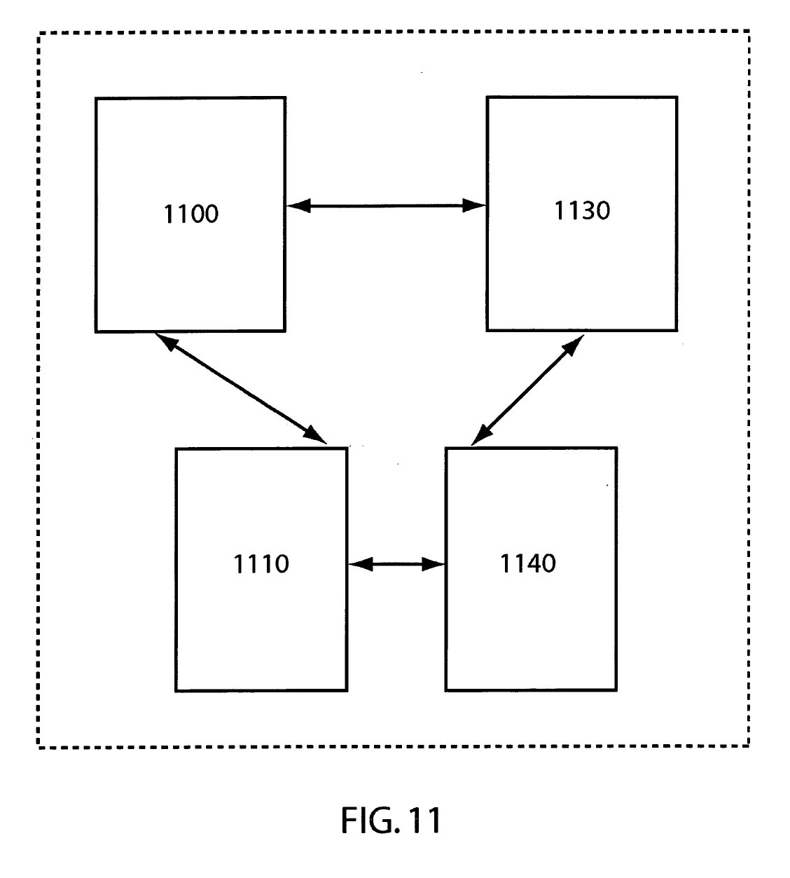

Once the information has been compiled, stored, and encrypted, it can only be viewed using a viewer or player. FIG. 10A shows a block diagram of a player device that can be used to play the compiled data in the form of the XML code forming a config file and also in the form of a set of data stored in a drive 170 or in repository 200.

FIG. 10C discloses a screen 930 showing the player which runs different screens for a lesson plan. In this view, there is a side screen 932 which is in the form of a tree or hierarchy which can be used to select different screens that will appear in a main screen 934. In this case, there is also a history bar or panel 933 which can present a plurality of history buttons 934. As shown in FIG. 9D these history buttons can represent a progression of screens for a user which can be for example an interactive question screen 938. Clicking each of the history buttons allows a user to proceed back to a previous screen wherein as shown in FIG. 9E these history buttons 936 are lined up on history bar 933. When the user clicks on one of these history buttons 933, the screen 940 changes to a previously presented screen such as the interactive question screen 938 shown in FIG. 9D.

FIG. 10F shows an example of an animation which includes progression buttons such as previous 952 and next 954.

FIG. 10G shows an example of a digital chapter in a main window. This digital chapter includes a history or tree structure panel 932 as described above and also a text screen 956.

FIG. 10H shows an example of a glossary window which can include a wordlist screen or section 960 including a search section 961 and a word listing section 962. If a user picks a particular word the definition for that word, and adjacent words is shown in an adjacent section 962.

FIG. 10I shows a pop-up form which can be used to show an index for the contents of the educational package.

FIG. 10J shows an example of a search form which can include a text prompt 982 for allowing a user to input information into text prompt 982 to search particular components stored in repository 200 wherein this listing is shown in box 984.

FIG. 10K discloses a flow chart for using the content engine to view an interactive educational pack. In this case, a user can initialize a program in step 985. Next, in step 986 the user can load the lesson in a config file. Next, the content engine can draw a main user interface in step 987. Next, in step 988 the startup routine is initialized. After that point the system in step 989 remains idle until step 990 a user executes an event such as pressing an interactive button such as history button 934. Next, the system queries the config file for the event and locates the associated reaction in step 991. In step 992 the system executes media tags responsible for this event. In step 993 the system initializes the appropriate media object wherein in step 994 this media object is loaded into the computer and the result is displayed on the screen in step 995. This process then returns back to step 989 wherein the system at this point remains idle until the next user initiated event is executed in step 990.

FIG. 10L shows the process for installing a content engine for future viewing of an educational pack. For example the process starts in step 998A wherein there is a query for a registration for an application. Next, in step 998B an edu-pak is loaded into a computer's hard drive. Next, in step 998C the file that has been loaded in step 998B is decrypted. In step 998D this file is loaded into a main program wherein the computer next checks for updates in step 998E. Finally, in step 998F the initialization ends and the program is fully installed.

FIG. 11 relates to a data structure that discloses a series of tables that can be used to relate the information in these tables and the parties meeting in these tables together. For example, table 1100 discloses a primary table of clients or users which can include teachers and professors, their addresses and contact information. Each user obtains a customer or user id which then allows that user to log into the current system. In addition, table 1110 includes the professional background and criteria for the user, wherein this professional information is matched to their user-id. This professional information can include professional accomplishments including awards, academic degrees, languages spoken, native language, courses taught or teaching, general academic field such as chemistry, biology, history, English, mathematics, electrical engineering etc. In addition, each general academic field will include sub specialties wherein a general academic field such as chemistry may include sub specialties such as biochemistry, physical chemistry, organic chemistry etc.

Accordingly, table 1130 can include a listing of consultant names and also their contact information. Each consultant has a corresponding consultant-id. This consultant-id is also listed in another related table 1140 which includes the professional information relating to that consultant. This professional information can include previous projects that were completed, a customer service rating, a listing of current projects or tasks assigned, vacation schedule, work location or residence, degrees obtained, degrees of current study, subspecialties or different areas of concentration of the degree, wherein as discussed above, the consultant could have obtained a degree in chemistry with a concentration in organic chemistry as a sub-specialty. In addition, other qualities documented could be languages known, or additional skills necessary for completing a task. In addition, this consultant could also have listed an authorship listing of previous digital files authored by that consultant or team of consultants.

This system would then include a means for matching a user with a consultant by matching the qualities that the user possessed with the qualities of the consultant. Therefore, a college Chemistry professor whose native language was Chinese and not English, could be matched with a consultant which had a degree in chemistry with a sub-specialty in organic chemistry and who is also fluent in Chinese. Therefore, if a user needed additional online assistance from a consultant, that consultant could interact with a user in a manner easier than if the consultant did not possess those qualities.

Accordingly, while at least one embodiment of the present invention has been shown and described, it is to be understood that many changes and modifications may be made thereunto without departing from the spirit and scope of the invention as defined in the appended claims.

1. A process for creating a computerized interactive academic lesson comprising:
a) searching through a plurality of data files;
b) selecting at least one of said plurality of data files;
c) adding at least one data file to said plurality of data files;
d) creating a content listing from said at least one selected file and said at least one added data file;
e) generating a config file based upon said content listing of said plurality of data files; and
f) storing said config files and said content listing as a separate interactive executable program.

2. The process as in claim 1, further comprising the step of generating at least one data file using a computerized data file generator.

3. The process as in claim 2, wherein said computerized data file generator generates a data file for an interactive question.

4. The process as in claim 2, wherein said computerized data file generator generates a data file for a quiz question.

5. The process as in claim 2, wherein said computerized data file generator generates a data file for compiling audio and video.

6. The process as in claim 2, wherein said computerized data file generator generates a data file for compiling a chapter and glossary section.

7. The process as in claim 2, wherein said computerized data file generator generates a data file for animation including 2D and 3D images.

8. The process as in claim 2, wherein said computerized data file generator generates a data file for a chart.

9. The process as in claim 1, further comprising encrypting a final content directory of at least one data file and said config file into one separate executable program.

10. The process as in claim 9, further comprising the step of coupling said encrypted final content directory with said config file to a content engine to create a final executable file.

11. The process as in claim 10, further comprising the step of copying said final executable file onto a drive for installation onto a user's computer.

12. The process as in claim 3, wherein said interactive question builder builds an interactive question using the following steps: activating an interactive question template; selecting whether to retrieve a data file or add a data file to said template.

13. The process as in claim 12, further comprising the step of selecting a type of question to be generated from the group consisting of: navigation questions, click correct, drag/drop, a crossword question or a fill-in question.

14. The process as in claim 13, wherein once the type of question to be generated has been selected, the process further comprises the step of generating an output question using a click frame, a click engine and then generating a final output.

15. The process as in claim 4, wherein said step of generating a data file for a quiz question comprises the following steps: selecting whether to create a new quiz or open an existing quiz; selecting whether to add or modify any existing data.

16. The process as in claim 15, wherein said step of generating a data file for a quiz question further comprises the step of mapping related questions and generating a general output file.

17. The process as in claim 15, wherein said step of generating a data file for a quiz question further comprises the step of creating at least one explanation for at least one answer to said quiz question.

18. The process as in claim 15, wherein said step of generating a data file for a quiz question further comprises the step of creating at least one analysis for an answer to the question.

19. The process as in claim 15, wherein said step of generating a data file for a quiz question further comprises the step of creating a hint for an answer to the quiz question.

20. The process as in claim 15, wherein said step of generating a data file for a quiz question further comprises creating a rating based upon how hard a particular question is relative to other questions.

21. The process as in claim 5, wherein said step of generating an audio visual file includes the step of creating pointers for an audio file.

22. The process as in claim 5, wherein said step of generating an audio visual file includes the step of creating pointers for a video file.

23. The process as in claim 6, wherein said step of creating a chapter and glossary section includes the steps of creating a text document and also creating at least one two dimensional or three dimensional image.

24. The process as in claim 8, wherein said step of creating a data file for a chart includes selecting at least one data file from an archive repository, and using an interactive chart creator to create a final chart.

25. The process as in claim 8, wherein said step of creating a data file for a chart includes selecting at least one data file from an archive repository, and using an static chart creator to create a final chart.

26. A system for creating a computerized interactive academic lesson comprising:
a) at least one computer having at least one data storage device, and at least one processor;
b) an archive of data files stored on said at least one data storage device;
c) at least one computerized course work builder stored in said data storage device and for sending a series of instructions to said at least one processor;
d) at least one content directory for controlling and organizing a selected set of content of said archive of data files;
e) at least one config file generator for generating a configuration file based upon a selected assortment of archived data files;
f) at least one encrypter for encrypting the configuration file and the associated set of archived data files in said at least one content directory to create a output file.

27. The system as in claim 26, further comprising at least one content engine for reading and presenting a course work lesson based upon said output file.

28. The system as in claim 26, wherein said at least one computerized course work builder comprises at least one interactive question builder.

29. The system as in claim 26, wherein said at least one computerized course work builder comprises at least one interactive question builder.

30. The system as in claim 26, wherein said at least one computerized course work builder comprises at least one quiz center question builder.

31. The system as in claim 26, wherein said at least one computerized course work builder comprises at least one chapter and glossary builder.

32. The system as in claim 26, wherein said at least one computerized course work builder comprises at least one chart builder.

33. The system as in claim 30, wherein said at least one quiz center question builder comprises at least one question field, a plurality of answer fields and a plurality of explanation fields with at least one explanation field being associated with a corresponding at least one answer.

34. The system as in claim 30, wherein said at least one quiz center question builder comprises at least one help screen for providing help in answering a question stored in said question field.

35. The system as in claim 30, wherein said at least one quiz center question builder comprises at least one hint field and a corresponding hint button so that when a user is having trouble with a question, that user can click on the hint button and reveal the hint text stored in the hint field to help the user answer the question.
